(19) United States
(12) Patent Application Publication
(10) Pub. No.: US 2004/0068819 A1
(43) Pub. Date: Apr. 15, 2004

(54) Moon trowel

(76) Inventor: Mario Nistico, Stuyvesant, NY (US)

Correspondence Address: Mario Nistico, 66 Church Street, Stuyvesant, NY, 12173, US

(21) Appl. No.: 10/268,389

(22) Filed: Oct. 10, 2002

(51) Int. Cl. B05C 17/10

(52) U.S. Cl. 15/235.4; 15/236.07; D08/45; D32/49

(57) ABSTRACT

The Moon Trowel is a tool of convenience. Because of the unique design and shape of the blade, anyone who uses it will not want to be without it. Its convex shaped blade matches perfectly with the inside contour of a five gallon bucket enabling the user to efficiently retrieve all materials, whatever they may be, from the inside of a bucket with little waste or effort. The idea is simple, match the shape of the trowel blade to the inside shape of a five gallon bucket which comes out to be a curve of 5&⅝ inch radius. A perfect fit means no manipulation of the tool to get it to work properly. Tools should not have to be manipulated to work . . . they should just work. The Moon Trowel works extremely well.

### BACKGROUND OF THE INVENTION

The Moon Trowel will be a useful and efficient tool to anyone involved in the construction field.

It retrieves material such as joint compound for sheetrock (tapers trade), cement or mortar including thin-set mortar for ceramic tile (masonry and laborers trade) and tar (roofers trade) out of five gallon buckets with absolutely zero waste. All the material inside the bucket is efficiently retrieved. Five gallon buckets are the most commonly used because they are so abundant and are just the right size for handling and transporting materials from one place to another.

Presently and, prior to my invention, the only tool available to get materials out of a five gallon bucket is any trowel with a straight edged blade. Using a straight edged tool to get something out of a round bucket is awkward, time consuming, and wasteful.

The manufacturing and marketing of the Moon Trowel will save contractors and do-it-yourselfers time and money.

### BRIEF SUMMARY OF THE INVENTION

Prior to my invention, anyone wishing to get materials such as joint compound, mortar or cement, thin set mortar, or tar out of a five gallon bucket would have to settle to use a trowel with a straight blade.

Because the inside of a five gallon bucket is curved (5%⅝ inch radius) the straight blade trowel would have to be manipulated in a manner as to retrieve the material, thus some of the material would fall off the trowel and remain in the bucket.

The Moon Trowel cures this. Its blade is shaped to the exact contour of the inside of a five gallon bucket. The Moon Trowel's sole purpose is to retrieve materials from within a five gallon bucket.

### BRIEF DESCRIPTION OF THE SEVERAL VIEWS OF THE DRAWING

FIG. 1:

1) shows the front view of the Moon Trowel.

2) points to the convex curve which makes the moon trowel unique from others. The curve is a 5&⅝ inch radius curve.

3) points to the blade body. The blade is 6 inches wide from left to right and 4 inches high from the top of the handle to the top of the convex curve.

4) points to the handle of the trowel.

FIG. 2

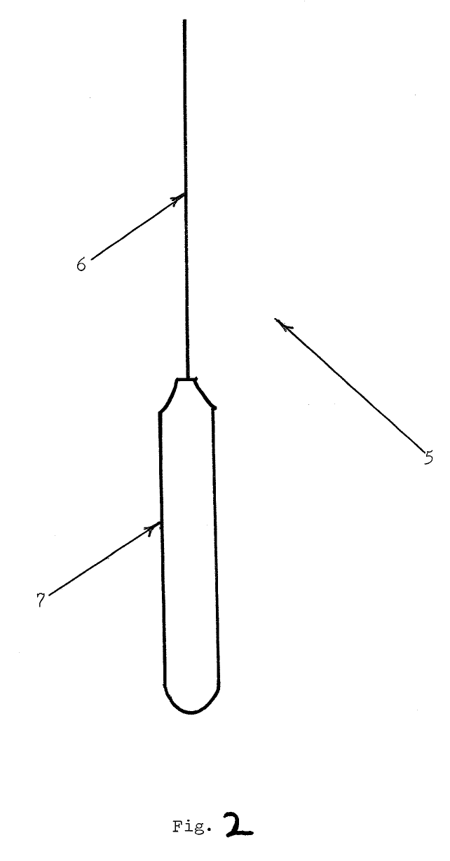

5) shows the side view of the Moon Trowel.

6) points to the side view of the blade body. The blade is approximately 1/16 of an incch thick.

7) points to the side view of the handle which is approximately ¾ of an inch thick.

### DETAILED DESCRIPTION OF THE INVENTION

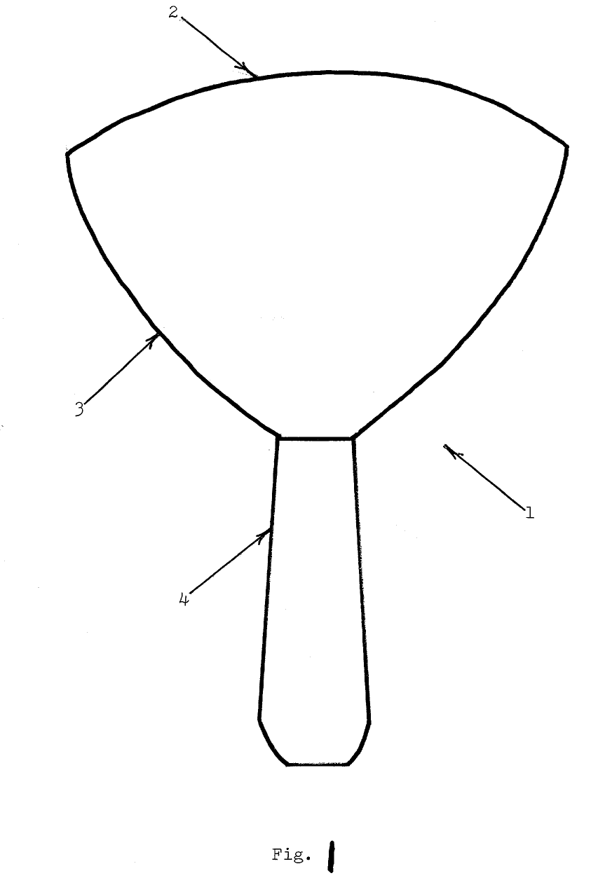

The Moon Trowel is a very simple tool. Simple to both use and make. To use it, grasp the tool by the handle (FIG. 1 ref.# 4) and use it to retrieve whtever material you need to get out of a five gallon bucket. The blade (FIG. 1 ref.#3) is shaped to meet and match the inside walls of a five gallon bucket. When retrieving materials with the Moon Trowel, you press the blade of the trowel against the inside of the bucket and using an upward motion, scrape the walls of the bucket clean. By the time the materials are used up, the Moon Trowel will have scraped out ALL (100%) of the material from the inside of the bucket.

The making of the Moon Trowel is just as easy as using it. To make or manufacture it, all you need to do is design a concave shaped die in which you stamp out a convex shaped blade. The die in this case would have a concave curve of 5&⅝ inch radius. When the die stamps out the blade, you are left with a convex shaped blade consisting of the same 5&⅝ inch radius curve (FIG. 1 ref.# 2).

In the past and present, anyone wishing to get materials out of a five gallon bucket has to settle for a trowel with a straight blade. This would be ideal if materials came in square five gallon buckets with flat sides, but they do not. They come in round five gallon buckets with curved sides.

The specific improement is really the shape of the blade (FIG. 1 ref #2 and 3)

1. “What I claim as my invention is the Moon Trowel which has a convex shaped blade with a 5&⅝ inch radius curve.”
